(19) United States
(12) Patent Application Publication
(10) Pub. No.: US 2026/0245482 A1
(43) Pub. Date: Aug. 20, 2026

(54) TABLE GENERATION APPARATUS, TABLE GENERATION METHOD AND PROGRAM

(71) Applicant: NIPPON TELEGRAPH AND TELEPHONE CORPORATION, Tokyo (JP)

(72) Inventor: Masanobu KII, Tokyo (JP)

(21) Appl. No.: 18/996,421

(22) PCT Filed: Jul. 21, 2022
(86) PCT No.: PCT/JP2022/028357

§ 371 Date: Jan. 17, 2025

(51) Int. Cl. G09C 1/00; G06F 21/62

(52) U.S. Cl. CPC G09C 1/00; G06F 21/62

(57) ABSTRACT

A table generation apparatus configured to create a table in which a distribution of noise z satisfies a condition for achieving (ε, δ)-differential privacy and approximates a discrete Laplace distribution, when a sum of one or more elements that are randomly selected from the table is used to define the noise z, is provided. The table generation apparatus includes circuitry configured to create a probability density function that satisfies the condition and is represented by a third array based on (i) a first array in which the one or more elements are initialized, (ii) a second array that is defined by the first array, and (iii) the third array that is created from the second array by a predetermined convolution operation; and create the table by using the first array.

### TECHNICAL FIELD

The present disclosure relates to a table generation apparatus, a table generation method, and a program.

### BACKGROUND ART

In privacy-preserving protocols, such as secure computation, information is often protected by adding noise (random numbers) to data. The noise used at this time needs to be kept almost completely secret to protect the information. The only information about the noise that may be known is a probability distribution that the noise follows, which is pre-shared among protocol participants. Not only an accurate value of the noise but also partial information, such as noise that is equal to or less than a certain value, needs to be kept secret.

In particular, there have been attempts to generate noise that follows a non-uniform distribution under the secure computation, in order to meet a safety standard for (ε, δ)-differential privacy. Even for this purpose, the noise needs to be kept almost completely secret. As a technique in the related art for achieving the purpose, there is a technique for generating a uniform random number in the secure computation and then converting the uniform random number via table lookup to generate noise that follows a target probability distribution (for example, Non-Patent Literatures 1 and 2).

On the other hand, in order to achieve the (ε, δ)-differential privacy by adding noise to an integer value that is derived from sensitive information, a probability mass function for noise needs to satisfy a certain condition. As a noise distribution satisfying this condition, a discrete Laplace distribution (also referred to as an exponential distribution, a two-sided geometric distribution, or the like) is known.

### CITATION LIST

### Non-Patent Literature

Non-Patent Literature 1: David Froelicher et al. “UnLynx: A Decentralized System for Privacy-Conscious Data Sharing”. In: Proceedings on Privacy Enhancing Technologies 2017.4 (Oct. 1, 2017), pp. 232-250. Issn: 2299-0984.
Non-Patent Literature 2: Kazuki Iwahana, Naoto Yanai, and Toru Fujiwara. “Privacy-Preserving Collaborative Learning Based on Integration of Secure Computation and Differential Privacy”. In: CSS 2020 Proceedings. Computer Security Symposium 2020. October 2020.

### SUMMARY OF INVENTION

### Technical Problem

However, in the above-described technique in the related art, it is difficult to accurately generate noise that follows the discrete Laplace distribution, and thus it is necessary to approximate the discrete Laplace distribution in some sense.

The present disclosure has been made in view of the above-described points, and an object of the present disclosure is to provide a technique capable of creating a table for generating noise that satisfies a certain condition and that follows a probability distribution that closely approximates a discrete Laplace distribution.

### Solution to Problem

In one aspect of the present disclosure, there is provided a table generation apparatus that creates a table T in which a distribution of noise z satisfies a condition for achieving (ε, δ)-differential privacy and which approximates a discrete Laplace distribution when a sum of n (where n is an integer of one or more) elements randomly selected from the table T is defined as noise z, the table generation apparatus including: a probability density function creation unit configured to create a probability density function f that satisfies the condition and is represented by a third array C_{sym}^{*n} by using a first array C in which an element C[0] is initialized, a second array C_{sym} defined by the first array, and the third array C_{sym}^{*n} created from the second array C_{sym} by a predetermined convolution operation; and a table creation unit configured to create the table T by using the first array C.

### Advantageous Effects of Invention

There is provided a technique capable of creating a table for generating noise that satisfies a certain condition and that follows a probability distribution that closely approximates a discrete Laplace distribution.

### BRIEF DESCRIPTION OF DRAWINGS

FIG. 1 is a diagram illustrating an example of a hardware configuration of a table creation device according to the present embodiment.

FIG. 2 is a diagram illustrating an example of a functional configuration of a table creation device according to the present embodiment.

FIG. 3 is a flowchart illustrating an example of table creation processing according to the present embodiment.

### DESCRIPTION OF EMBODIMENTS

Hereinafter, one embodiment of the present invention will be described. In the following embodiment, a table creation device 10 that can create a table (array) for generating noise that satisfies a certain condition (an (ε, δ)-differential privacy condition to be described later) and that follows a probability distribution that closely approximates a discrete Laplace distribution will be described.

By using the table created by the table creation device 10 according to the present embodiment, it is possible to generate, via table lookup, the noise that satisfies the certain condition and that follows the probability distribution that closely approximates the discrete Laplace distribution, under secure computation. Here, noise generation via the table lookup is a method in which a value is randomly extracted from a table created in advance and then is used as the noise (for example, Non-Patent Literatures 1 and 2). The noise generation via the table lookup has an advantage that computational complexity is significantly reduced compared to a method of mathematically transforming uniform random numbers made in plaintext,

### <Condition for Achieving (ε, δ)-Differential Privacy>

Achieving (ε, δ)-differential privacy by adding noise to an integer value derived from sensitive information indicates that a probability mass function f(k) for noise satisfies the condition below.

When s∈{−Δ, −Δ+1, . . . , +Δ} is arbitrarily chosen, and

$${A}_{s} = \{ k \vert k ∈ ℤ , f ( k ) \leq {e}^{ε} f ( k - s ) \} \qquad [ Math . 1 ]$$

the above is set,

$$( {Pr}_{Z \sim f ( k )} [ Z ∈ {A}_{s} ] = ) {\sum }_{k ∈ {A}_{s}} f ( k ) \geq 1 - δ \qquad [ Math . 2 ]$$

the above is satisfied.

Here, an integer 4 (≥1) is a value called sensitivity, and is determined according to processing (for example, calculation of statistics and the like) of generating a value to be protected by the (ε, δ)-differential privacy. Hereinafter, the above-described condition is also referred to as the “(ε, δ)-differential privacy condition”.

### <Preparation: Convolution of Arrays>

In preparation, convolution of arrays is defined. For arrays A[0], . . . , A[L] of length L+1 and a positive integer n (=1, 2, . . . ), a new array A^{*n} is defined below, and the new array A^{*n} is referred to as convolution of array A.

$${A}^{* n} [ k ] = {\sum }_{α} {{\prod }_{j = 1}}^{n} A [ {α}_{j} ] ( k = 0 , … , nL ) \qquad [ Math . 3 ]$$

Here, the sum Σ_{α}, is an n-tople α=(α₁, . . . , αₙ) of non-negative integers, and

is the sum related to all sums satisfying the equation below.

$${\sum }_{j = 1}^{n} {α}_{j} = k \qquad [ Math . 4 ]$$

It should be noted that A=A^{*n}.

When the array A having the length L+1 is convolved, A^{*n}[k] becomes a polynomial including A[0], . . . , A[k] for k=0, . . . , L, and further, A^{*n}[k] becomes a linear expression with respect to A[k].

### <Hardware Configuration Example of Table Creation Device 10>

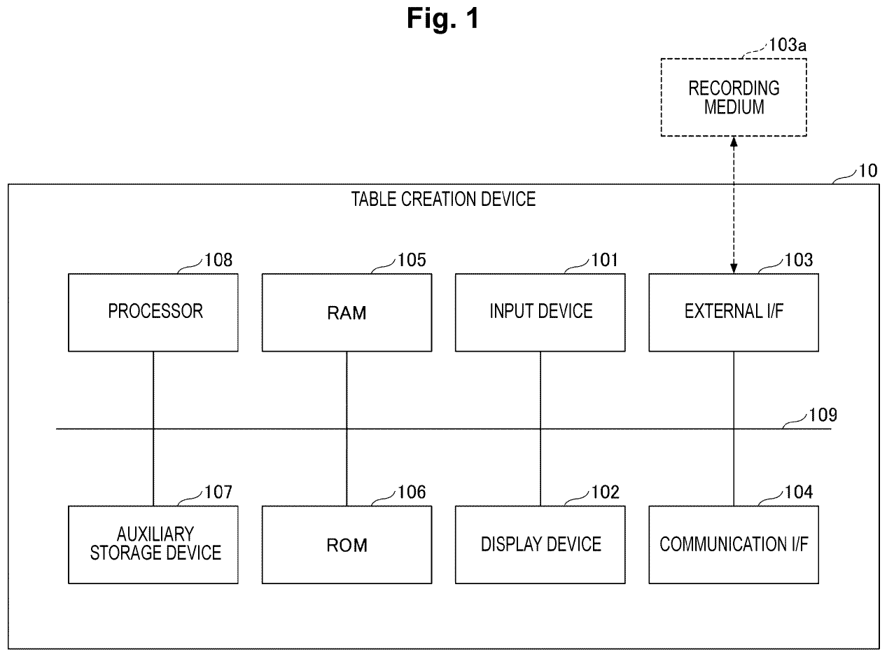

FIG. 1 illustrates a hardware configuration example of the table creation device 10 according to the present embodiment. As illustrated in FIG. 1, the table creation device 10 according to the present embodiment includes an input device 101, a display device 102, an external I/F 103, a communication I/F 104, a random access memory (RAM) 105, a read only memory (ROM) 106, an auxiliary storage device 107, and a processor 108. These hardware components are communicatively connected to one another via a bus 109.

The input device 101 includes, for example, a keyboard, a mouse, a touch panel, a physical button, and/or the like. The display device 102 is, for example, a display, a display panel, or the like. Note that the table creation device 10 may not include, for example, at least one of the input device 101 or the display device 102.

The external I/F 103 is an interface with an external device such as a recording medium 103a. The table creation device 10 can perform reading or writing with respect to the recording medium 103a via the external I/F 103. Examples of the recording medium 103a include a flexible disk, a compact disc (CD), a digital versatile disc (DVD), a secure digital memory card (SD memory card), and a universal serial bus (USB) memory card.

The communication I/F 104 is an interface for connecting the table creation device 10 to a communication network 20. The RAM 105 is a volatile semiconductor memory (storage device) that temporarily holds programs and data. The ROM 106 is a non-volatile semiconductor memory (storage device) capable of holding programs and data even when the power is turned off. The auxiliary storage device 107 is, for example, a storage device such as a hard disk drive (HDD), a solid state drive (SSD), or a flash memory. The processor 108 is, for example, an arithmetic device such as a central processing unit (CPU).

The table creation device 10 according to the present embodiment has the hardware configuration illustrated in FIG. 1, so that table creation processing to be described later can be implemented. Note that the hardware configuration illustrated in FIG. 1 is an example, and the hardware configuration of the table creation device 10 is not limited thereto. For example, the table creation device 10 may include a plurality of the auxiliary storage devices 107 and a plurality of the processors 108, may not include a part of the illustrated hardware, or may include various types of hardware other than the illustrated hardware.

### <Functional Configuration Example of Table Creation Device 10>

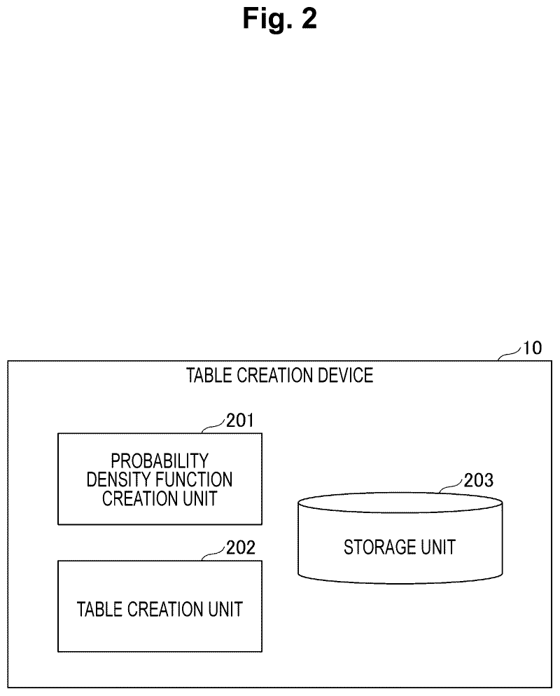

FIG. 2 illustrates a functional configuration example of the table creation device 10 according to the present embodiment. As illustrated in FIG. 2, the table creation device 10 according to the present embodiment includes a probability density function creation unit 201, a table creation unit 202, and a storage unit 203. Note that the probability density function creation unit 201 and the table creation unit 202 are implemented, for example, when one or more programs installed in the table creation device 10 causes the processor 108 to execute processing. Furthermore, the storage unit 203 is implemented by, for example, a storage device such as the auxillary storage device 107 or the RAM 105.

The probability density function creation unit 201 creates a probability density function f(k) that satisfies an (ε, δ)-differential privacy condition. At this time, during the creation of the probability density function f(k), the probability density function creation unit 201 creates an array C as an element of a table T for generating noise z that satisfies the (ε, δ)-differential privacy condition and follows a probability distribution closely approximating the discrete Laplace distribution, an array Cay determined by the array C, and an array C_{sym}^{*n} obtained by convolving the array C_{sym}. The probability density function f(k) is expressed by the array C_{sym}^{*n}.

By using the array C created by the probability density function creation unit 201, the table creation unit 202 creates a table T for generating the noise z that satisfies the (ε, δ)-differential privacy condition and follows the probability distribution that closely approximates the discrete Laplace distribution.

The storage unit 203 stores the arrays C, C_{sym}, and C_{sym}^{*n} created by the probability density function creation unit 201, the table I created by the table creation unit 202, and the like.

### <Table Creation Processing>

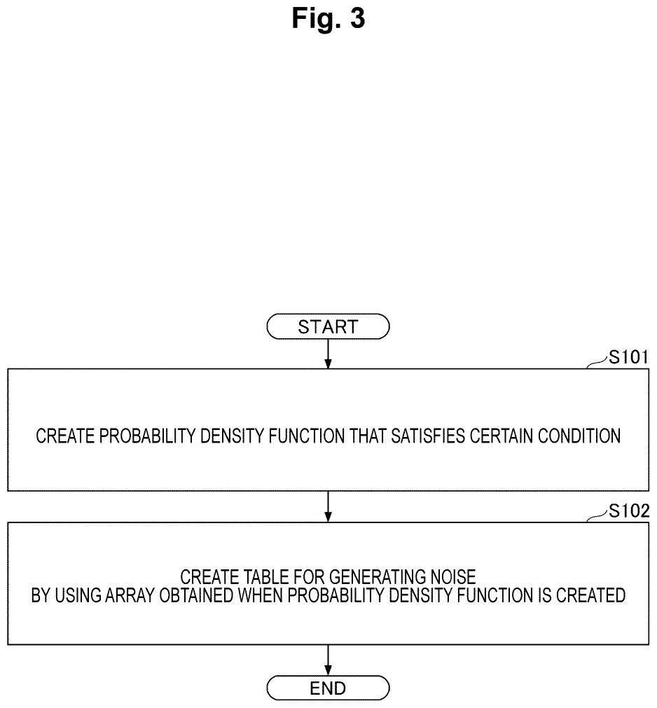

Table creation processing according to the present embodiment will be described below with reference to FIG. 3. Hereinafter, a case where, when n (=1, 2, . . . ) elements are randomly taken from the table T, and the sum of the n elements is expressed as z, a table T, in which the distribution of z satisfies the (ε, δ)-differential privacy condition and closely approximates the discrete Laplace distribution, is created, will be described.

The probability density function creation unit 201 creates a probability density function f(k) that satisfies the (ε, δ)-differential privacy condition (step S101). Here, the probability density function creation unit 201 creates the probability density function f(k) by procedures from Procedure 1 to Procedure 3 below.

Procedure 1: First, the probability density function creation unit 201 initializes C[0] to an appropriate positive integer. Here, in order to reduce the size of the table T that is finally obtained, C[0] is preferably small. On the other hand, when C[0] is too small, the subsequent processing may not proceed well, and thus it is necessary to set C[0] to an appropriate value. For example, when n=1, it is best to define C[0] as below.

$$C [ 0 ] = \{ \begin{matrix}1 & ( {e}^{ε} \geq 2 ) \\ ⌈ \frac{1}{{e}^{ε} - 1} ⌉ & ( {e}^{ε} < 2 )\end{matrix} \qquad [ Math . 5 ]$$

$$Here ,$$

$$⌈ x ⌉ \qquad [ Math . 6 ]$$

is a ceiling function, that is, the smallest integer equal to or greater than x. Note that e^{ε}>1 is satisfied due to ε>0.

Procedure 2: Next, the probability density function creation unit 201 sets a variable L to zero and then executes procedures from Procedure 2-1 to Procedure 2-5 below.

(Procedure 2-1) For i=0, . . . , L, the array C_{sym} is defined below.

$${C}_{sym} [ i ] = {C}_{sym} [ ( 2 L + 2 ) - i ] = C [ i ]$$

Here, C_{sym}[L+1] is used as a symbol (indeterminate) until the next procedure 2-2.

(Procedure 2-2) Real numbers c₀ and c₁ satisfying C_{sym}^{*n}[L+1]=c₁C[L+1]+c₀ are calculated. Note that, as described above, c₀ and c₁ can be expressed by a polynomial for C[0], . . . , C[L], and c₁ is not zero.

(Procedure 2-3) At the end of array C,

$$( C [ L + 1 ] = ) ⌊ \frac{{e}^{ε} {C}_{sym}^{* n} [ L ] - {c}_{0}}{{c}_{1}} ⌋ \qquad [ Math . 7 ]$$

the above is added. Here,

$$⌊ x ⌋ \qquad [ Math . 8 ]$$

the above is a floor function, that is, the greatest integer that does not exceed x.

(Procedure 2-4) The variable L is increased by one.

(Procedure 2-5) In a case where the condition (end condition) below is satisfied, the processing proceeds to Procedure 3. Otherwise, the processing returns to Procedure 2-1.

$$L + 1 \geq Δ and \frac{{\sum }_{k = 0}^{Δ - 1} {C}_{sym}^{* n} [ k ]}{{\sum }_{k = 0}^{2 L - 1} {C}_{sym}^{* n} [ k ]} < δ \qquad [ Math . 9 ]$$

Here, instead of determining the end condition regarding iteration from Procedure 2-1 to Procedure 2-4 according to the above-described conditions, for example, the number of iterations from Procedure 2-1 to Procedure 2-4 may be determined in advance.

Note that when the value of C[0] set in the above-described procedure 1 is too small, C_{sym}^{*n}[L+1]=C_{sym}^{*n}[L] is obtained during the iteration from procedure 2-1 to procedure 2-4, and the processing does not proceed, Therefore, the value of C[0] in a case of n>1 is preferably determined by a pre-test or the like.

Procedure 3: In a case where a length of the array C obtained in the above-described procedure 2 is L+1,

$$f ( k ) = \frac{{C}_{sym}^{* n} [ k + L ]}{{\sum }_{k = 0}^{2 L - 1} {C}_{sym}^{* n} [ k ]} \qquad [ Math . 10 ]$$

when the above is set, this is a probability density function that satisfies the (ε, δ)-differential privacy condition. Note that at this time, the end condition of Procedure 2-5 is the same value as the relationship set below.

$${\sum }_{k = 0}^{Δ - 1} f ( k ) < δ \qquad [ Math . 11 ]$$

Next, by using the array C obtained when the probability density function f(k) is created, the table creation unit 202 creates a table T for generating the noise z that satisfies the (ε, δ)-differential privacy condition and that follows the probability distribution that closely approximates the discrete Laplace distribution (step S102). Specifically, when the length of the array C is L+1, the table creation unit 202 creates the table storing C[L−|k|] pieces of each k=−L, −L+1, . . . , L. Thus, when the n (=1, 2, . . . ) elements are randomly taken from the table T, and the sum of the n elements is expressed as z, the table T in which the distribution of z satisfies the (ε, δ)-differential privacy condition and closely approximates the discrete Laplace distribution is obtained.

Note that the probability density function f(k) is not used when the table T is created in step S102 described above. Therefore, Procedure 3 of step S101 described above may not be executed.

### SUMMARY

As described above, when probabilities f(0), . . . , f(L) are obtained, the table creation device 10 according to the present embodiment uses the fact that a probability f(L+1) is similar to the value C_{sym}^{*n}[L+1] obtained by convolution of the array, and that this value becomes a linear function with respect to a new element C[L+1] of the array C, and then the table creation device 10 generates a table by iterative operations of the probability density function f that satisfies the (ε, δ)-differential privacy condition. Thus, the table creation device 10 according to the present embodiment can configure a desired table T from the array C.

### <Effects>

The table creation device 10 according to the present embodiment mainly has the following effects (1) and (2).

(1) Noise required to achieve the (ε, δ)-differential privacy can be generated using a noise generation method using noise generation via table lookup, which provides low computational complexity and simple implementation.

(2) When used in a case of n≥2, a small δ can be obtained with a smaller table than that in a case of n=1, Specifically, the size (length) of the table is roughly proportional to (1/δ)^{1/n}.

Therefore, by using the table T created by the table creation device 10 according to the present embodiment in a protocol that requires secret noise (noise generation under secure computation) such as (ε, δ)-differential privacy, it is possible to execute the protocol more efficiently.

The present invention is not limited to the foregoing specifically disclosed embodiments, and various modifications, changes, combinations with any known technique, and the like can be made without departing from the scope of the claims.

### Reference Literature

Reference Literature 1: Cynthia Dwork et al. “Our Data, Ourselves: Privacy Via Distributed Noise Generation”. In: Advances in Cryptology-EUROCRYPT 2006. Ed. by Serge Vaudenay. Lecture Notes in Computer Science. Berlin, Heidelberg: Springer, 2006, pp. 486-503. isbn: 978-3-540-34547-3.
Reference Literature 2: Arpita Ghosh, Tim Roughgarden, and Mukund Sundararajan. “Universally Utility-Maximizing Privacy Mechanisms”. In: Proceedings of the Forty-First Annual ACM Symposium on Theory of Computing. STOC '09. New York, NY, USA: Association for Computing Machinery, May 31, 2009, pp. 351-360. isbn: 978-1-60558-506-2.

### REFERENCE SIGNS LIST

10 Table creation device
101 Input device
102 Display device
103 External I/F
103a Recording medium
104 Communication I/F
105 RAM
106 ROM
107 Auxiliary storage device
108 Processor
109 Bus
201 Probability density function creation unit
202 Table creation unit
203 Storage unit

1. A table generation apparatus configured to create a table in which a distribution of noise z satisfies a condition for achieving (ε, δ)-differential privacy and approximates a discrete Laplace distribution, when a sum of one or more elements that are randomly selected from the table is used to define the noise z, the table generation apparatus comprising:
circuitry configured to
create a probability density function that satisfies the condition and is represented by a third array, based on (i) a first array in which the one or more elements are initialized, (ii) a second array that is defined by the first array, and (iii) the third array that is created from the second array by a predetermined convolution operation; and
create the table by using the first array.

2. The table generation apparatus according to claim 1, wherein when the first array is defined as C, a length of the first array C is set to L+1, and L is an integer of zero or more, the circuitry is configured to create the table that stores C[L−|k|] pieces of each k=−L, −L+1, . . . , L.

3. The table generation apparatus according to claim 1, wherein when the first array is defined as C, the second array is defined as C_{sym}, and the third array is defined as C_{sym}^{*n}, the circuitry is configured to
define the second array C_{sym} by C_{sym}[i]=C_{sym}[(2L+2)−i]=C[i](i=0, . . . , L) for L (where L is an integer of zero or more),
calculate real numbers c₀ and c₁ satisfying C_{sym}^{*n}[L+1]=c₁C[L+1]+c₀,
set a maximum integer that does not exceed (e^{ε}_{Csym}^{*n}[L]−c₀)/c₁ to C[L+1] for predetermined value of ε that is greater than 0,
repeat incrementing L by one until an end condition is satisfied, and
create C_{sym}^{*n}[k+L]/(a sum of _{Csym}^{*n}[j] from j=0 to j=2L−1) as the probability density function.

4. The table generation apparatus according to claim 3, wherein the end condition is that L+1≥Δ (where Δ is greater than or equal to 1 and is an integer representing sensitivity) and that (a sum of C_{sym}^{*n}[j] from j=0 to j=Δ−1)/(a sum of C_{sym}^{*n}[j] from j=0 to j=2L−1) is less than δ (where δ is a predetermined value greater than 0).

5. The table generation apparatus according to claim 3, wherein the end condition is that a predetermined number of repetitions is reached.

6. A table generation method for creating a table in which a distribution of noise z satisfies a condition for achieving (ε, δ)-differential privacy and approximates a discrete Laplace distribution, when a sum of one or more elements that are randomly selected from the table is used to the noise z, the table generation method comprising:
creating a probability density function that satisfies the condition and is represented by a third array, based on (i) a first array in which the one or more elements are initialized, (ii) a second array that is defined by the first array, and (iii) the third array that is created from the second array by a predetermined convolution operation; and
creating the table by using the first array.

7. A non-transitory computer readable storage medium storing a program that causes a computer to execute the table generation method of claim 6.
